(19) United States
(12) Patent Application Publication
(10) Pub. No.: US 2007/0139445 A1
(43) Pub. Date: Jun. 21, 2007

(54) Method and apparatus for displaying rotated images

(75) Inventors: Moinul H. Khan, Austin, TX (US); Mark N. Fullerton, Austin, TX (US); Anitha Kona, Austin, TX (US); Patricia J. Hoover, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/303,117

(22) Filed: Dec. 16, 2005

(51) Int. Cl. G09G 5/00

(52) U.S. Cl. 345/649

(57) ABSTRACT

A graphics system includes a single buffer coupled between a graphics controller and a display controller. The graphics controller rotates a frame generated by an application and writes the rotated frame into the buffer. The rotation is performed a segment (e.g., a quartile of a frame) at a time. Each time the display controller completes displaying a frame quartile, the display controller signals the graphics controller to rotate a corresponding quartile of a next frame. The reduction in buffer space reduces power consumption and improves performance of the system.

### BACKGROUND

### Background

Image rotation is performed when the content generated by an application is at a different orientation from that of a display. For example, the orientation of the display on a wireless multimedia handheld device, e.g., a personal digital assistant (PDA), a cellular phone, or a laptop, may sometimes be incompatible with the orientation of a video recording downloaded to the handheld device. Rotation hardware may be used to rotate the video to fit the display format.

If video frames are not rotated or updated properly, artifacts (e.g., partial frame updates or image tearing) may appear on the display. A frame rotation and updating process may involve an application writing a frame to its buffer, a rotation engine rotating the frame, and a display controller displaying the rotated frame. The operations of the components participating in the process need to be coordinated to prevent the occurrence of artifacts. The term “component” used herein refers to a software module or a hardware unit.

Conventional systems typically adopt a double buffering scheme to coordinate the operations of frame rotations and updates. Double buffering also promotes efficiency. When one component read from one of the double buffers, the other component may concurrently write into the other one of the double buffers. FIG. 1 shows an example of a conventional system 10 using the double buffering scheme. System 10 includes a processor 11, a graphics controller 12 for image rotation, and a display controller 13 for controlling the displaying of the rotated image on a display 14. A first pair of buffers (15, 16) is maintained between processor 11 and graphics controller 12, and a second pair of buffers (17, 18) is maintained between graphics controller 12 and display controller 13. When an application executed by processor 11 generates an image, processor 11 writes the image into one of the buffers (e.g., buffer 15). In the meantime, graphics controller 12 reads from the other buffer (e.g., buffer 16). Thus, the use of double buffers (15, 16) allows concurrent read and write operations. Likewise, when graphics controller 12 writes a rotated image into buffer 17, display controller 13 may read from buffer 18 for display. Thus, hardware rotation may be performed concurrently with frame display. As long as display controller 13 reads data from a buffer after graphics controller 13 completes writing to that buffer, the displayed image should be free of artifacts. However, managing multiple copies of buffers increases memory consumption.

### BRIEF DESCRIPTION OF THE DRAWINGS

Embodiments are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a prior system using a double buffering scheme.

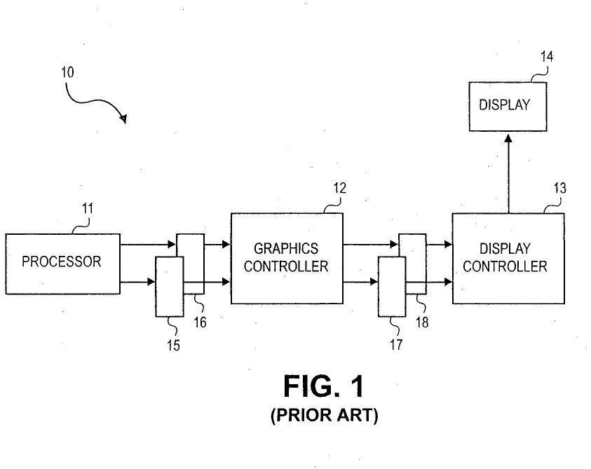

FIG. 2 is a block diagram of graphics system using a single buffer between a graphics controller and a display controller.

FIG. 3 is a signaling diagram showing the synchronization between the graphics controller and the display controller.

FIG. 4 is a flowchart showing the operations performed by the graphics controller and the display controller.

FIG. 5 is a block diagram of a wireless handheld unit including the graphics system of FIG. 2.

### DETAILED DESCRIPTION

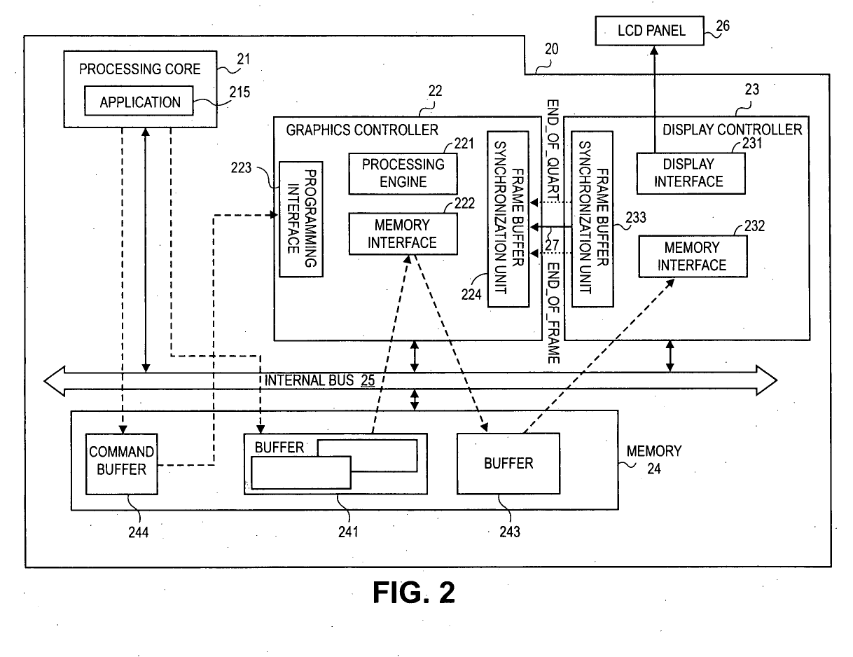

FIG. 2 shows an embodiment of a graphics system 20 including a processing core 21, a graphics controller 22, and a display controller 23, all of which are coupled to a memory 24 via an internal bus 25. Graphics controller 22 and display controller 23 may be additionally coupled to a dedicated synchronization channel to transmit synchronization signals. Graphics controller 22 processes images generated by an application 215 running on processing core 21. In one embodiment, application 215 is a graphics or video application generating graphics images or video frames. The term “image” and “frame” are used interchangeably herein. Display controller 23 is connected to a display, e.g., a liquid crystal display (LCD) panel 26.

In one embodiment, processing core 21 may be a microprocessor suitable for portable or handheld applications, e.g., a PDA, a cellular phone, a laptop, or other similar devices. In one embodiment, processing core 21 may be an Intel Xscale® Core, designed and manufactured by Intel Corporation of Santa Clara, Calif. In one embodiment, processing core 21 may be a video capturing device (e.g., a camera) or a video accelerator unit that decompresses a video (e.g., a video playback device). Memory 24 may be a static random access memory (SRAM), dynamic random access memory (DRAM), or similar volatile memory devices suitable for low power and high performance applications. Processing core 21, graphics controller 22, display controller 23, and memory 24 may be integrated into a single chip or package.

In one embodiment, memory 24 may include a pair of buffers 241 accessible by application 215 and graphics controller 22 for implementing a double-buffering scheme in which the two buffers are used in a ping-pong fashion. When application 215 is writing to one buffer (e.g., a front buffer), graphics controller 22 may read from the other buffer (e.g., a back buffer). After the read and write operations are completed, graphics controller 22 may read from the front buffer and application 215 may write into the back buffer. Thus, the read and write operations may be performed in parallel.

Memory 24 may also include a single buffer 243 accessible by graphics controller 22 and display controller 23 for implementing a Just-In-Time Rotation (JIT-R). Rather than waiting for display controller 23 to complete displaying an entire frame, graphics controller 22 starts rotating and writing the next frame into buffer 243 when a partial current frame, e.g., a segment of the current frame, is displayed. Graphics controller 22 rotates just enough of the next frame to fit into the buffer space occupied by the current frame segment that has been displayed. In one embodiment, the portion of the next frame replacing the displayed segment in buffer 243 is a corresponding segment of the next frame. The term “displayed segment” refers to the frame segment that has been displayed. A corresponding segment is the segment occupying the same location of a rotated frame as the displayed segment. As the frames are rotated and displayed a segment at a time, a single buffer may be used between graphics controller 22 and display controller 23. The savings in buffer space may allow memory 24 to be integrated into a single chip with other hardware components of system 20. Thus, system performance may be improved as a result of reduced external memory access. As most of the memory access is contained in a chip, power consumption may be greatly reduced.

It should be understood that a single buffer may also be used between application 215 and graphics controller 22. However, in scenarios where it is not desirable to tightly couple an application with graphics controller 22, a double buffering implementation may be more suitable. For example, an application may generate an entire frame of a coarse resolution and then progressively refine the resolution. Thus, the above-described segment-by-segment approach may not be suitable as the application may need to continuously access the entire frame buffer during a write operation.

In the embodiment as shown in FIG. 2, buffer 243 may be viewed as comprising a plurality of buffer segments, each segment storing a portion of a rotated image. For clarity of the discussion herein, it is assumed that buffer 243 is partitioned into four quartiles, each storing a quarter of an image. It should be understood that the number of segments in buffer 243 may be a design choice and may be any number other than four.

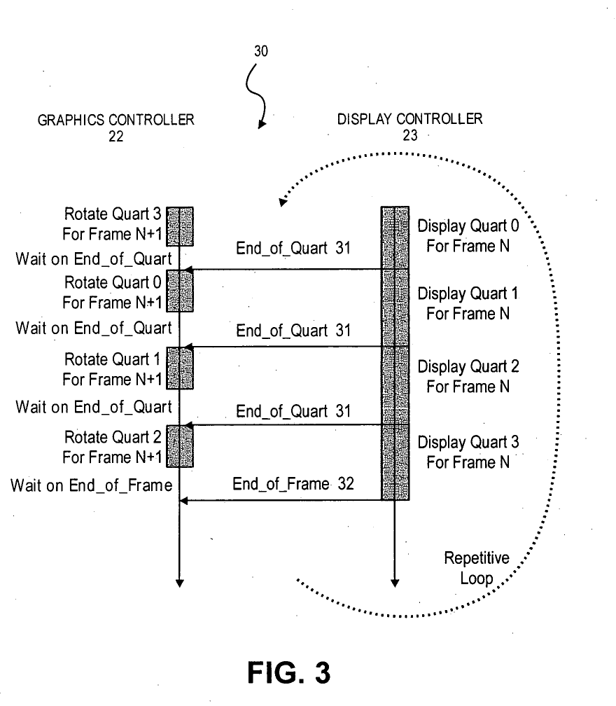

To ensure that the displayed image is free of artifacts, synchronization may take place between graphics controller 22 and display controller 23. The synchronization may be in the form of fine-grained signaling between graphics controller 22 and display controller 23. The term “fine-grained” is used to indicate activities relating to a fractional portion of a frame. FIG. 3 shows an embodiment of a signaling diagram 30 for the fine-grained signaling between graphics controller 22 and display controller 23. As graphics controller 22 typically completes rotating a quartile faster than display controller 23 displaying a quartile, graphics controller 22 may wait idly until display controller 23 send a signal. In one embodiment, display controller 23 sends an END_OF_QUART 31 signal to graphics controller 22 at the end of displaying each quartile, except the last quartile of a frame. After displaying the last quartile of a frame, display controller 23 sends an END_OF_FRAME 32 signal to graphics controller 22. Each time after display controller 23 completes displaying a quartile (e.g., quartile 0 of frame N), graphics controller 22 rotates the corresponding quartile of the next frame (e.g., quartile 0 of frame N+1) and overwrites the displayed quartile (e.g., quartile 0 of frame N) in buffer 243. After rotating and writing the quartile, graphics controller 22 waits on the next END_OF_QUART 31 or END_OF_FRAME 32 signal to rotate the next quartile.

As graphics controller 22 typically completes rotating a quartile faster than display controller 23 displaying a quartile, the graphics controller may generate more memory access requests in a given time period than the display controller. At some point of time, graphics controller 22 and display controller 23 may concurrently request access to different portions of buffer 243. For example, graphics controller 22 may request to write data into quartile 3 when display controller 23 reads data from quartile 0. In one embodiment, concurrent requests may be queued up in respective memory interfaces 222 and 232 to serialize the memory access.

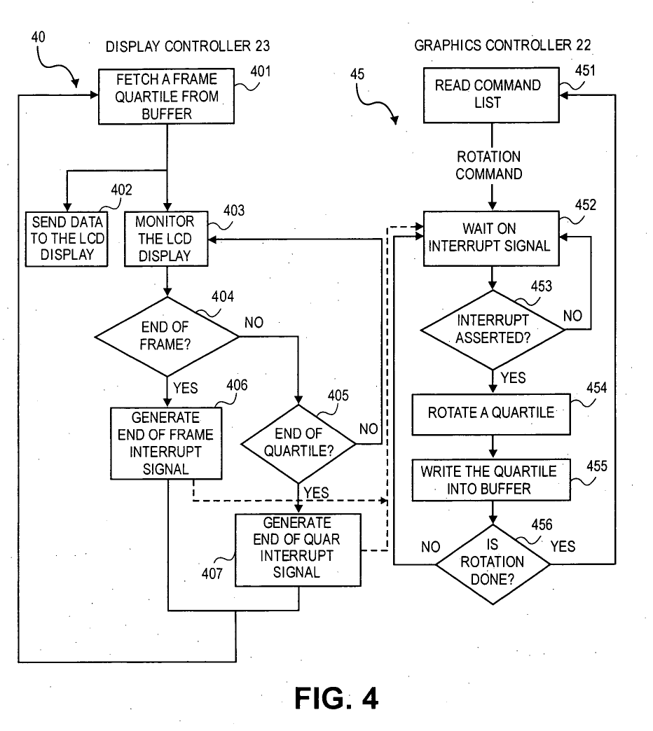

FIG. 4 includes flowcharts 40 and 45 showing an embodiment of the operations of display controller 23 and graphics controller 22, respectively, for displaying a rotated image. Referring also to FIG. 2, initially, software executed by processing core 21 sends display controller 23 and graphics controller 22 the start addresses of each frame quartile and the quartile length. Using the address, at block 401, a memory interface 232 of display controller 23 fetches the frame quartile from buffer 243. At block 402, display controller 23 sends the data to LCD panel 26 via a display interface 231. LCD panel 26 displays the data in a raster fashion, that is, line by line from the top to the bottom of the display screen. In parallel to the data display, at block 403, display interface 231 monitors the display process to determine whether the display has reached an end of a frame or an end of a quartile. If an end of a frame is detected at block 404, a frame buffer synchronization unit 233 of display controller 23 generates an END_OF_FRAME interrupt signal to graphics controller 23 at block 406. If an end of quartile is detected at block 405, frame buffer synchronization unit 233 generates an END_OF_QUART interrupt signal to graphics controller 23 at block 407. The dotted lines leading blocks 406 and 407 to block 452 indicate the interrupt signals transmitting to graphics controller 22. After generating either of the interrupt signals, display controller 23 is ready to fetch the next frame quartile at block 401. If it is neither an end of a frame nor an end of a quartile, display controller 23 loops back to block 403 to continue monitoring the display process on LCD panel 26.

Flowchart 45 shows the operations performed by graphics controller 22 to synchronize with the activities of display controller 22. At block 451, software executed by processing core 21 commands a programming interface 223 of graphics controller 22 to read a command list stored in a command buffer 244 of memory 24. In one embodiment, the command list includes a rotation command. The rotation command directs graphics controller 22 to rotate the frames generated by application 215. After reading the rotation command, in one embodiment, graphics controller 22 may initialize buffer 243, e.g., by writing an initial rotated frame to buffer 243. The initialization operation may be performed when the first frame of a frame sequence is rotated. Thereafter, graphics controller 22 waits on an interrupt signal (indicated by the dotted line) from display controller 23 at block 452. Graphics controller 22 begins operating on a quartile by quartile basis upon receiving an interrupt signal from display controller 23.

At block 453, a frame buffer synchronization unit 224 of graphics controller 22 receives the interrupt signal from display controller 23. Upon receiving the interrupt, at block 454, a memory interface 222 of graphics controller 22 retrieves data from one of buffers 241 and in parallel forwards the data to a processing engine 221 for rotation. After rotating a quartile of a frame, at block 455, memory interface 222 writes the rotated frame quartile into buffer 243. Graphics controller 22 continues the operations of blocks 452-455 until the rotation of a frame is completed at block 456. Graphics controller 22 then loops back to block 451 to read the next rotation command, if any, to continue rotating the next frame. The operation of frame rotation is completed when there is no more rotation command in command buffer 244.

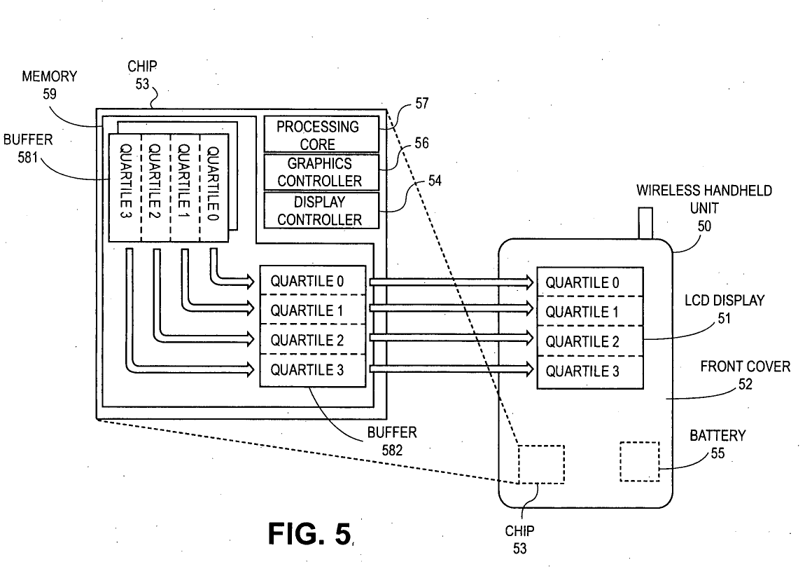

FIG. 5 shows an embodiment of a system utilizing the concept of graphics system 20 as described above. In the embodiment, a wireless handheld unit 50 powered by a battery unit 55 operates to receive multimedia data over a network, e.g. local area network, or the Internet. Wireless handheld unit 50 may alternatively be powered by alternating currents (AC) through an electrical wire connecting to a power outlet. Wireless handheld unit 50 includes a display 51 (e.g., a LCD panel) on a front cover 52 for displaying an image comprising image quartiles. In one embodiment, the displayed image quartiles are stacked from top to bottom of display 51. Behind front cover 52 is a single chip 53 including a graphics system (e.g., system 20). Chip 53 includes a memory 59, a display controller 54, a graphics controller 56, and a processing core 57. Memory 59 includes a pair of buffers 581 for temporarily storing the frames generated by a graphics or video application running on processing core 57. In the embodiment as shown, the image quartiles in buffer pair 581 are stacked horizontally side by side. Memory 59 also includes a single buffer 582 for temporarily storing the image quartiles after rotation by graphics controller 56. The embodiment of FIG. 5 illustrates how the hardware rotation changes the image orientation on display 51 relative to the orientation in buffer 581. However, it should be understood that the absolute image orientations may depend on the application or hardware design and may differ from the embodiment as shown.

In the foregoing specification, specific embodiments have been described. It will, however, be evident that various modifications and changes can be made thereto without departing from the broader spirit and scope of the appended claims. The specification and drawings are, accordingly, to be regarded in an illustrative rather than a restrictive sense.

What is claimed is:

1. A method comprising:
displaying a partial frame of a current frame stored in a display buffer; and
replacing the partial frame of the current frame with a corresponding partial frame of a next frame upon completion of displaying the partial frame of the current frame.

2. The method of claim 1 wherein the replacing further comprises:
rotating the corresponding partial frame of the next frame; and
writing the corresponding partial frame into the display buffer.

3. The method of claim 1 wherein displaying further comprises:
signaling an interrupt to indicate an end of displaying a partial frame.

4. The method of claim 3 further comprising:
waiting on the interrupt to begin rotating the corresponding partial frame.

5. The method of claim 1 wherein displaying further comprises:
entirely displaying the current frame before displaying the partial frame of the next frame.

6. An apparatus comprising:
a graphics controller to rotate a frame;
a display controller to control displaying the frame; and
a memory including a display buffer coupled between the graphics controller and the display controller, wherein the graphics controller writes into the display buffer a partial frame of a next frame before the display controller completes displaying an entire frame of a current frame.

7. The apparatus of claim 6 wherein the display controller further comprises:
a synchronization interface to send an interrupt signal to the graphics controller, the signal indicating an end of displaying the partial frame.

8. The apparatus of claim 6 wherein the graphics controller further comprises:
a synchronization interface to receive an interrupt signal from the display controller, the signal prompting the frame rotation.

9. The apparatus of claim 6 wherein the graphics controller further comprises:
a processing engine to rotate a corresponding partial frame of the next frame after a partial frame of the current frame is displayed.

10. The apparatus of claim 6 further comprising:
a processing core to issue a rotation command to the graphics controller.

11. The apparatus of claim 10 wherein the memory further comprises:
a pair of buffers accessible by the processing core and the graphics controller to store the current frame and the next frame before the rotation.

12. The apparatus of claim 10 wherein the processing core, the memory, the graphics controller, and the display controller are located on a single chip.

13. A system comprising:
a graphics controller to rotate a frame;
a display controller to control displaying the frame;
a memory including a display buffer coupled between the graphics controller and the display controller, wherein the graphics controller writes into the display buffer a partial frame of a next frame before the display controller completes displaying an entire frame of a current frame; and
a battery to power the graphics controller, the display controller, and the memory.

14. The system of claim 13 wherein the display controller further comprises:
a synchronization interface to send a signal to the graphics controller, the signal indicating an end of displaying the partial frame.

15. The system of claim 13 wherein the graphics controller further comprises:
a synchronization interface to receive a signal from the display controller, the signal prompting the frame rotation.

16. The system of claim 13 wherein the graphics controller further comprises:
a processing engine to rotate a corresponding partial frame of the next frame after a partial frame of the current frame is displayed.

17. The system of claim 13 further comprising:
a processing core to issue a rotation command to the graphics controller.

18. The system of claim 17 wherein the memory further comprises:
a pair of buffers accessible by the processing core and the graphics controller to store the current frame and the next frame before the rotation.

19. The system of claim 17 wherein the processing core, the memory, the graphics controller, and the display controller are located on a single chip.
